(19) United States
(12) Patent Application Publication
(10) Pub. No.: US 2013/0283229 A1
(43) Pub. Date: Oct. 24, 2013

(54) METHOD FOR AUTOMATICALLY GENERATING AND LAUNCHING APPLICATION SOFTWARE THROUGH A SINGLE ENTRY POINT OF A STORE PLATFORM

(71) Applicant: INSYDE SOFTWARE CORP., Taipei City (TW)

(72) Inventor: Po-Wei HSU, Taipei City (TW)

(73) Assignee: INSYDE SOFTWARE CORP., Taipei City (TW)

(21) Appl. No.: 13/685,211

(22) Filed: Nov. 26, 2012

(30) Foreign Application Priority Data
Apr. 18, 2012 (TW) 101113731

(51) Int. Cl. G06F 9/44

(52) U.S. Cl. CPC G06F 8/30; G06F 8/60
USPC 717/106

(57) ABSTRACT

A method for automatically generating and launching application software through a single entry point of a store platform provides a continuous service for automatically generating and launching APP through an APP store platform providing application software (APP). After users briefly describe and/or input information, the APP store platform can automatically generate an APP product and directly launch the APP product thereon. The store platform can further launch APP products to other external APP store platforms. Accordingly, a convenient service with continuity and coherence for automatically generating and launching APP products can be provided.

### BACKGROUND OF THE INVENTION

1. Field of the Invention

The present invention relates to a method for automatically generating application software and more particularly to a method for automatically generating and launching application software (APP) through a single entry point of a store platform.

2. Description of the Related Art

Since the advent of smart phones, besides serving as communication tools, the powerful and multi-functional smart phones have been almost equivalent to small computers and become indispensable tools to all walks of life. The widespread smart phones further boost the market of products related thereto. According to the announcement on the official website of Apple Inc., the number of half million smart phones downloading APP from Apple has reached approximately 25 billion times since July 2008 as a proven record indicative of how popular the APP is. Besides being developed by all major software companies, the so-called APP also comes from self-employed developers. A lot of APPS developed by independent self-employed developers are related to art creation, information sharing and knowledge, ranging from a diversified and stunning selections of electronic books, travel writing, photographic work and the like. Despite the creative concepts behind the APP, not every author is familiar with the programming language required to develop the APP. To authors in certain categories of APP, unfamiliar programming language is apparently a major barrier for them to develop APP.

To tackle the foregoing problem, some APP vendors have already provided an online service of automatically generating application software. Benefited from such service, authors can directly develop APP without familiarizing themselves with programming languages. After APP is completed, it still needs to be launched to an application store platform. However, the service of automatically generating APP and the service of launching APP to an application store platform pertain to two different kinds of services. After a developer completes the development of application software, the application software is unable to be launched to an application store platform until the developer registers to the application store platform to get an account number and use it to log in the application store platform. To authors who develop and intend to launch their APPs to application store platforms, these two services are complicated, time-consuming and even unfriendly for developers to use for lack of continuity and coherence between the two services.

### SUMMARY OF THE INVENTION

A first objective of the present invention is to provide a method for automatically generating and launching APP through a single entry point of a store platform capable of providing a continuous and friendly operation interface for users to automatically generate an APP product using an automatic APP generation service and launch the APP product to an APP store platform through a single entry point of a store platform.

To achieve the foregoing objective, the method has steps of:

providing a store platform for users to browse information therefrom and operate the store platform;

providing an automatic APP generation service on the store platform providing an APP auto builder to automatically generate an APP product after users input related information of the APP product; and

providing an APP launching and downloading service on the store platform for uploading the APP product to the store platform.

From the foregoing, the method performs both the automatic APP generation service and the APP launching and downloading service using an APP store platform. After users log in a single entry point of the APP store platform, the automatic APP generation service is used to automatically generate an APP product and upload the APP product to the APP store platform. In other words, the completed APP product is directly launched to the APP store platform. Given the method, users can conveniently develop an APP product and launch the APP product to the APP store platform generating the APP product through a single entry point of the APP store platform, thereby providing users with a continuous and friendly operation interface.

A second objective of the present invention is to provide a method for automatically generating APP and launching the APP to external APP store platforms through a single entry point of a store platform.

To achieve the foregoing objective, the foregoing method further has steps of:

collecting and analyzing at least one external store platform, wherein each one of the at least one external store platform has an application programming interface;

providing the at least one analyzed external store platform for users to select at least one of the at least one analyzed external store platform to launch an APP product; and

uploading the APP product to the selected at least one external store platform.

The benefits of the method reside in that users can upload a generated APP product to other APP store platforms to launch the APP product through a single entry point. Accordingly, users won't have to register to each external APP store platform and log in each APP store platform to upload an APP product.

Other objectives, advantages and novel features of the invention will become more apparent from the following detailed description when taken in conjunction with the accompanying drawings.

### BRIEF DESCRIPTION OF THE DRAWINGS

FIG. 1 is a schematic diagram of a system architecture in accordance with the present invention;

FIG. 2 is a flow diagram of an embodiment of a method for automatically generating and launching APP through a single entry point of a store platform in accordance with the present invention;

FIGS. 3 to 8 are operational schematic diagrams of windows associated with steps of the method in FIG. 2; and

FIG. 9 is a flow diagram of another embodiment of a method for automatically generating and launching APP through a single entry point of a store platform in accordance with the present invention.

### DETAILED DESCRIPTION OF THE INVENTION

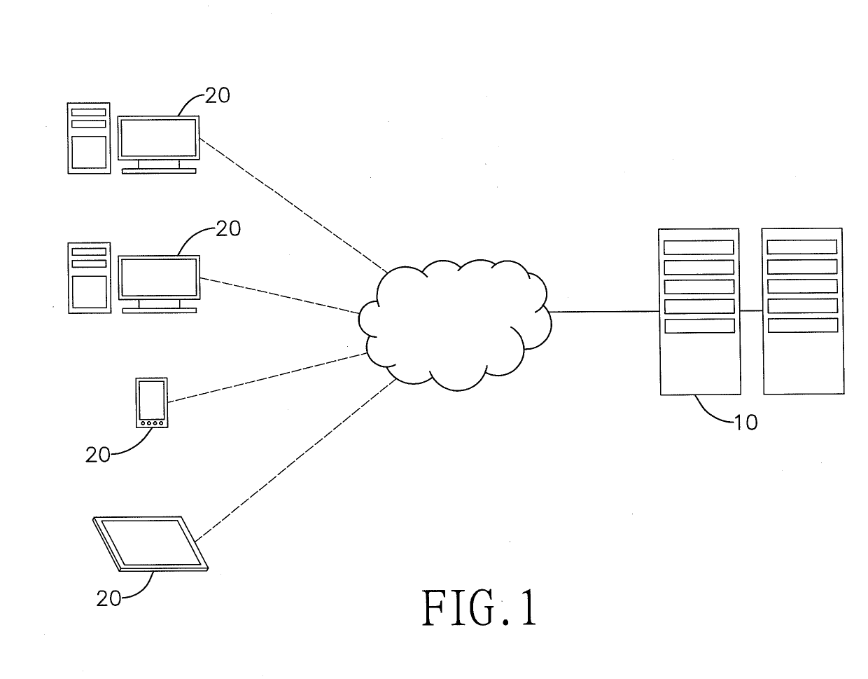

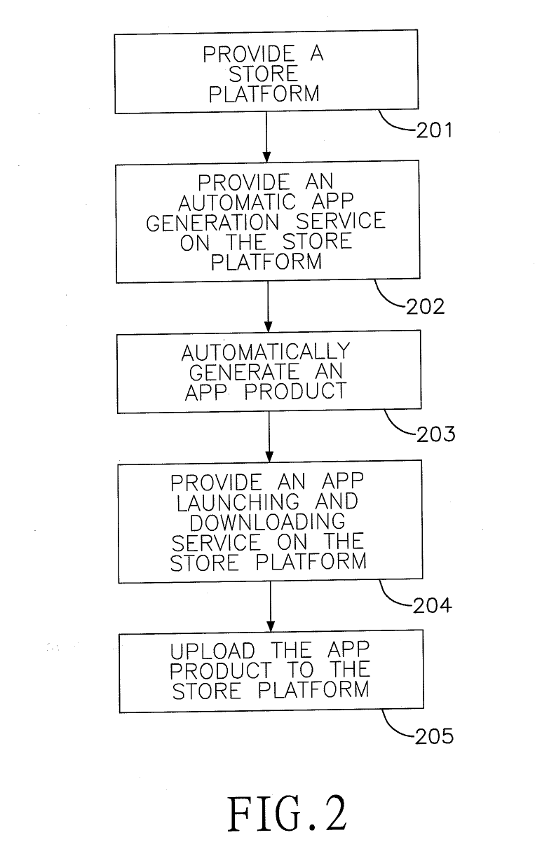

With reference to FIGS. 1, 4 and 8, a system architecture for automatically generating and launching APP through a single entry point of a store platform in accordance with the present invention provides a web store platform 10 for various users' electronic devices 20 to enter the web store platform 10 through a network. The electronic devices 20 may be smart phones, tablet PCs, notebook computers, desktop computers or any other equipment capable of accessing the Internet. The web store platform 10 has an APP development program 11 and an APP download program 12. The APP development program 11 serves to provide an automatic APP generation service to registered developers in generation of corresponding APP products designed by the registered developers. The APP download program 12 serves to provide an APP launching and downloading service. The APP products include but not limited to those generated by the APP development program 11.

Based on the foregoing system architecture, an embodiment of a method for automatically generating and launching APP through a single entry point of a store platform in accordance with the present invention has the following steps.

Step 201: Provide a store platform. Users can browse information on and operate the store platform.

Step 202: Provide an automatic APP generation service on the store platform. The automatic APP generation service provides an APP auto builder.

Step 203: Automatically generate an APP product. The APP auto builder allows users to automatically generate an APP product after inputting related information.

Step 204: Provide an APP launching and downloading service on the store platform.

Step 205: Upload the APP product to the store platform. The APP launching and downloading service allows users to upload the APP product to the store platform.

The foregoing method is described in details as follows.

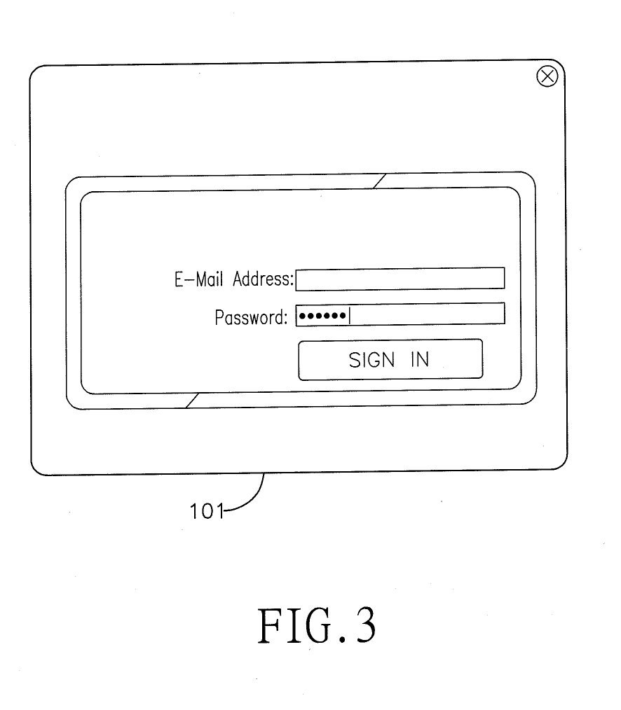

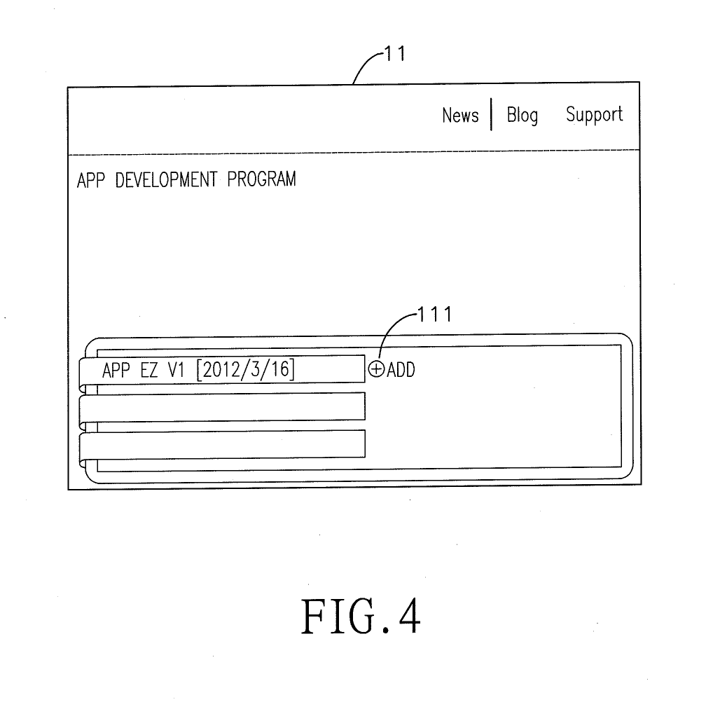

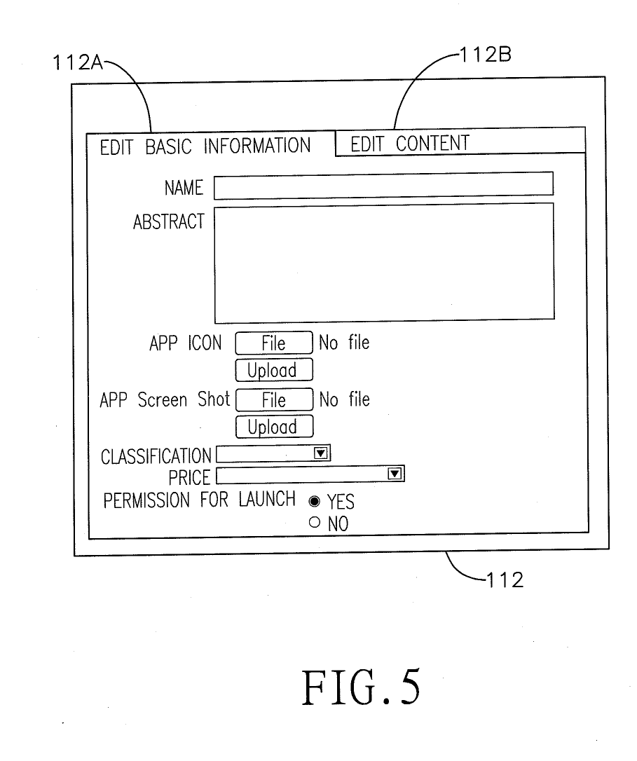

With reference to FIG. 3, the store platform 10 generates a login window 101 for users registered as developers to enter the store platform 10. After logging in, users may choose to initiate the APP development program 11 as shown in FIG. 4. The APP development program 11 provides an “ADD” option 111 for users to add APP. After users pick the “ADD” option, the APP auto builder is executed. With reference to FIG. 5, the APP auto builder provides an edit interface 112 having an “EDIT BASIC INFORMATION” option 112A and an “EDIT CONTENT” option 112B. The “EDIT BASIC INFORMATION” option 112A allows users to input and configure basic information of an APP, such as, name, abstract, ICON, classification, price, permission for launching APP and the like.

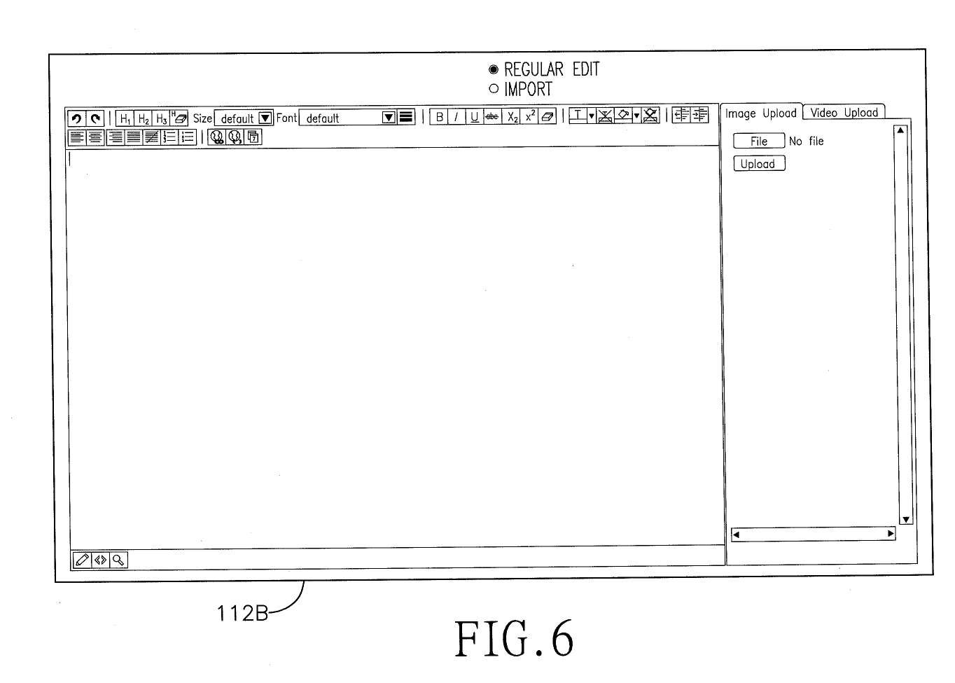

After completing the input of the basic information, users can pick the “EDIT CONTENT” option 112B. In the present embodiment, picking the “EDIT CONTENT” option 112B further provides a “REGULAR EDIT” option and an “IMPORT” option. If the regular editing option is selected, as shown in FIG. 6, a window for regular editing is shown for users to input or edit content of an APP product, such as inputting texts, uploading image or video information and the like. If the “IMPORT” option is selected, a window for importing information is shown for users to enter a source of the imported information.

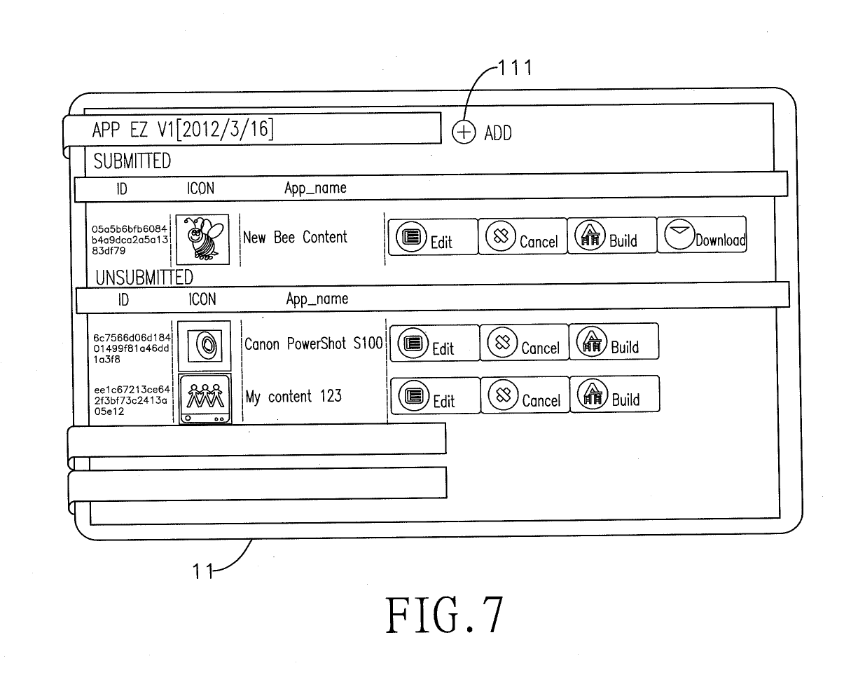

After the completion of inputting basic information and editing content, the APP development program 11 returns to the window as shown in FIG. 4 and further displays existing and newly added APPs on the window. In the present embodiment, the APP development program 11 classifies the displayed APPs into two categories respectively on a submitted zone and an unsubmitted zone as shown in FIG. 7. The newly added APP is displayed on the unsubmitted zone. Several options, such as “EDIT”, “CANCEL”, “BUILD” and the like, are available to each APP in the unsubmitted zone. When users press the “BUILD” option, the APP development program 11 executes an automatic APP generation function to generate an APP and relocate the building APP from the unsubmitted zone to the submitted zone. Several options, such as “EDIT”, “CANCEL”, “BUILD”, “DOWNLOAD” and the like, are available to each APP in the submitted zone. The “EDIT” option allows users to edit the basic information and content of an APP again, and the “BUILD” option allows users to generate an edited APP again. The “DOWNLOAD” option allows users to download an APP.

The foregoing description facilitates understanding of substantial processes for the APP development program to generate an APP with the automatic APP generation service. After executing the APP development program 11 to complete an APP product, users can automatically launch the APP product to the APP download program 12 on the store platform if the permission for launching APP is “YES” when filling in the basic information.

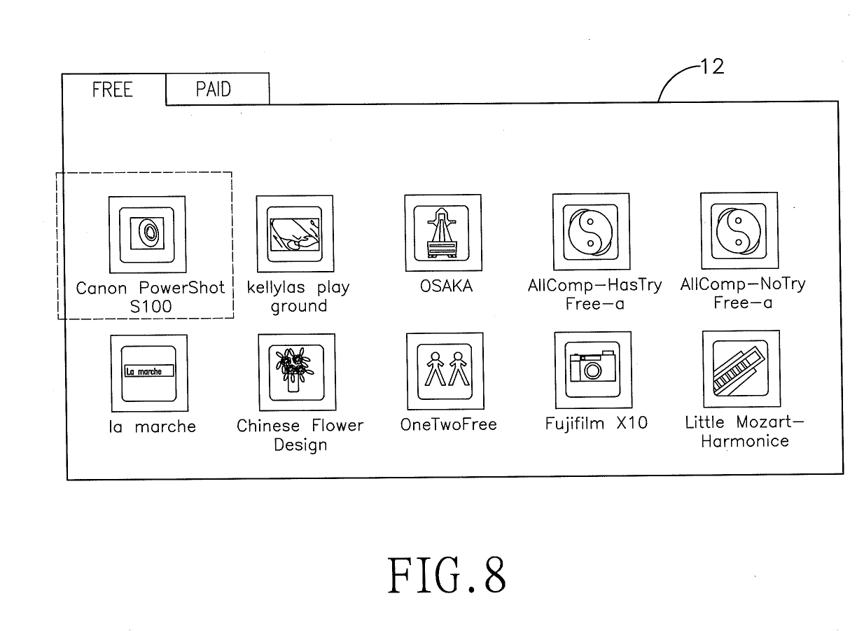

With reference to FIG. 8, the APP download program 12 can be presented in the form of web pages. Similar to most APP stores, the launched APP products can be classified into “FREE” and “PAID” categories, which are launched to different web pages for users to download. An APP product generated by the APP development program 11 is distributed to the web page of the APP download program 12 categorized as a “FREE” or “PAID” APP depending on the prices in the basic information of the APP products.

From the foregoing, the present invention provides a continuous operation mode for automatically generating and launching APP. Accordingly, users can easily develop APP products through a friendly interface.

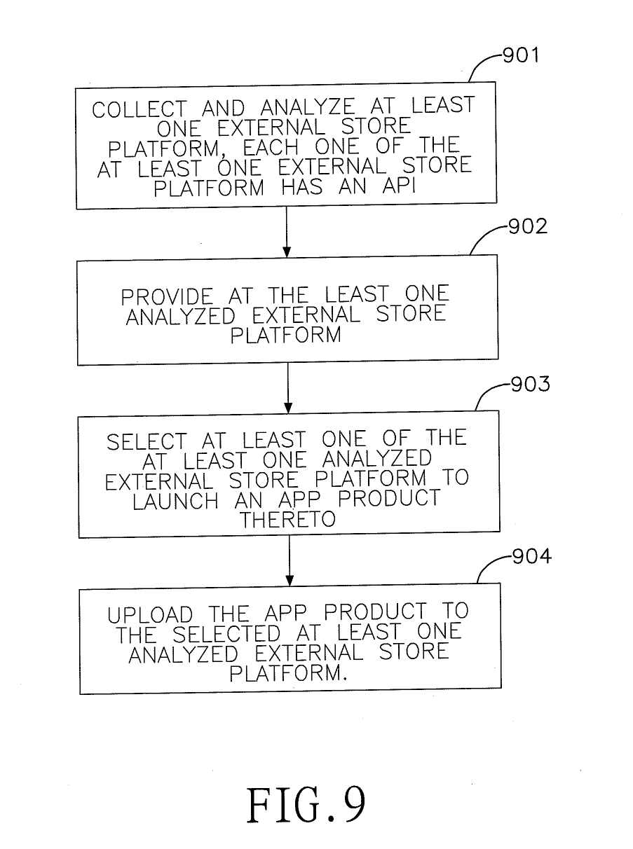

In the foregoing embodiment, the present invention provides users with a continuous operation method to generate an APP product and launch the APP product through a single entry point of a store platform. The generated APP product is automatically launched to a portal store platform. Additionally, the present invention further allows users to launch APP products to other store platforms other than the portal store platform through the same point of entry. Specifically, with reference to FIG. 9, another embodiment of a method for automatically generating and launching APP through a single entry point of a store platform in accordance with the present invention further performs the following steps.

Step 901: Collect and analyze at least one external store platform, each one of the at least one external store platform has an application programming interface (API).

Step 902: Provide the at least one analyzed external store platform.

Step 903: Select at least one of the at least one analyzed external store platform to launch an APP product thereto.

Step 904: Upload the APP product to the selected at least one analyzed external store platform.

As different APP store platforms have different APIs and uploading rules, the APP launching and downloading service provided by the store platform 10 collects and analyzes the API of each external APP store platform and further analyzes its uploading rules so as to integrate the analyzed results into the API of the automatic APP generation service. Hence, users can configure the permission for launching an APP product to an external APP store platform and further select an external APP store platform for the APP product to be launched thereto on the edit interface of the APP auto builder.

Moreover, for any uploading request of an APP product, each APP store platform normally asks for a registered account number and password before users log therein. Instead of manual registration, the APP launching and downloading service of the present invention automatically registers to each external APP store platform to acquire an account number. When users complete an APP product on the store platform 10, the APP launching and downloading service logs in the external APP store platforms with the account number acquired by the service and uploads and launches the APP product to the external APP store platform according to the uploading rules of the external APP store platform. As a result, users won't have to register to each external APP store platform and log in each APP store platform to upload an APP product, thereby significantly increasing the convenience for users to develop and launch APP products.

Even though numerous characteristics and advantages of the present invention have been set forth in the foregoing description, together with details of the structure and function of the invention, the disclosure is illustrative only. Changes may be made in detail, especially in matters of shape, size, and arrangement of parts within the principles of the invention to the full extent indicated by the broad general meaning of the terms in which the appended claims are expressed.

What is claimed is:

1. A method for automatically generating and launching application software (APP) through a single entry point of a store platform comprising steps of:
providing a store platform for users to browse information therefrom and operate the store platform;
providing an automatic APP generation service on the store platform providing an APP auto builder to automatically generate an APP product after users input related information of the APP product; and
providing an APP launching and downloading service on the store platform for uploading the APP product to the store platform.

2. The method as claimed in claim 1, wherein the APP auto builder provides an edit interface having:
an edit basic information option for users to input and configure basic information of the APP product; and
an edit content option providing a regular edit option for users to input or edit content of the APP product.

3. The method as claimed in claim 2, wherein the edit content option further provides an import option to generate an import window for users to input a source of imported information.

4. The method as claimed in claim 2, wherein the basic information of the APP product includes name, abstract, ICON, classification, price and permission for launching APP.

5. The method as claimed in claim 4, wherein the APP launching and downloading service provides web pages for launched APP products classified into free and paid categories to be distributed to the corresponding web pages, and an APP product generated by the APP auto builder is allocated to a corresponding free or paid category depending on the price configured in the basic information of the APP product.

6. The method as claimed in claim 1, further comprising steps of:
collecting and analyzing at least one external store platform, wherein each one of the at least one external store platform has an application programming interface;
providing the at least one analyzed external store platform for users to select at least one of the at least one analyzed external store platform to launch an APP product; and
uploading the APP product to the selected at least one external store platform.

7. The method as claimed in claim 2, further comprising steps of:
collecting and analyzing at least one external store platform, wherein each one of the at least one external store platform has an application programming interface;
providing the at least one analyzed external store platform for users to select at least one of the at least one analyzed external store platform to launch an APP product; and
uploading the APP product to the selected at least one external store platform.

8. The method as claimed in claim 3, further comprising steps of:
collecting and analyzing at least one external store platform, wherein each one of the at least one external store platform has an application programming interface;
providing the at least one analyzed external store platform for users to select at least one of the at least one analyzed external store platform to launch an APP product; and
uploading the APP product to the selected at least one external store platform.

9. The method as claimed in claim 4, further comprising steps of:
collecting and analyzing at least one external store platform, wherein each one of the at least one external store platform has an application programming interface;
providing the at least one analyzed external store platform for users to select at least one of the at least one analyzed external store platform to launch an APP product; and
uploading the APP product to the selected at least one external store platform.

10. The method as claimed in claim 5, further comprising steps of:
collecting and analyzing at least one external store platform, wherein each one of the at least one external store platform has an application programming interface;
providing the at least one analyzed external store platform for users to select at least one of the at least one analyzed external store platform to launch an APP product; and
uploading the APP product to the selected at least one external store platform.

11. The method as claimed in claim 6, wherein the APP launching and downloading service automatically registers to each one of the at least one external APP store platform to acquire an account number, logs in the external APP store platforms with the account numbers, and then uploads an APP product to the external APP store platform.

12. The method as claimed in claim 7, wherein the APP launching and downloading service automatically registers to each one of the at least one external APP store platform to acquire an account number, logs in the external APP store platforms with the account numbers, and then uploads an APP product to the external APP store platform.

13. The method as claimed in claim 8, wherein the APP launching and downloading service automatically registers to each one of the at least one external APP store platform to acquire an account number, logs in the external APP store platforms with the account numbers, and then uploads an APP product to the external APP store platform.

14. The method as claimed in claim 9, wherein the APP launching and downloading service automatically registers to each one of the at least one external APP store platform to acquire an account number, logs in the external APP store platforms with the account numbers, and then uploads an APP product to the external APP store platform.

15. The method as claimed in claim 10, wherein the APP launching and downloading service automatically registers to each one of the at least one external APP store platform to acquire an account number, logs in the external APP store platforms with the account numbers, and then uploads an APP product to the external APP store platform.
